(19) United States
(12) Patent Application Publication
(10) Pub. No.: US 2024/0232131 A1
(43) Pub. Date: Jul. 11, 2024

(54) SYSTEMS, DEVICES AND METHODS FOR DATA PROCESSING AND PRESENTATION

(71) Applicant: Odin's Eye Technologies, Inc., San Diego, CA (US)

(72) Inventor: Jason Crowell, San Diego, CA (US)

(73) Assignee: Odin's Eye Technologies, Inc., San Diego, CA (US)

(21) Appl. No.: 18/541,779

(22) Filed: Dec. 15, 2023

Related U.S. Application Data
(63) Continuation of application No. PCT/US2022/033534, filed on Jun. 15, 2022.
(60) Provisional application No. 63/210,872, filed on Jun. 15, 2021.

(51) Int. Cl. G06F 16/11; G06F 16/14

(52) U.S. Cl. CPC G06F 16/116; G06F 16/156

(57) ABSTRACT

Unstructured data is received from a database server and is associated with an organization. A construct is also received that includes an organization structure associated with the organization for a function of that organization, the organization structure including multiple elements. The construct further includes fields associated with two of the elements, each field including a mapping between its two elements. The fields are populated by mapping a first portion of the unstructured data to the construct to generate an updated construct including field entries. The updated construct is converted into a data interchange format file. A query is received from a user for a second portion of the unstructured data that is subsumed by the first portion. A portion of the file corresponding to the second portion of the unstructured data is converted into response data, including a specification of a visual display of the response data.

### CROSS-REFERENCE TO RELATED APPLICATIONS

This application is a bypass continuation of International Application No. PCT/US2022/033534, entitled “SYSTEMS, DEVICES AND METHODS FOR DATA PROCESSING AND PRESENTATION” and filed Jun. 15, 2022, which in turn claims the priority benefit, under 35 U.S.C. 119(c), of U.S. application Ser. No. 63/210,872, entitled “SYSTEMS, DEVICES AND METHODS FOR DATA PROCESSING AND PRESENTATION” and filed Jun. 15, 2021. Each of these applications is incorporated herein by reference in its entirety for allow purposes.

### BACKGROUND

Interrelated documents, such as legal documents, often create a dense network of interconnected clauses and terms that govern specific organizational functions or activities. While a well-structured legal document can be computationally studied in isolation, the lack of effective tools to bridge the interconnections across multiple documents addressing a single issue makes the study of a large network of interconnected legal documents much more complicated. Conventional approaches to document analysis using artificial intelligence (“AI”) involve the analysis of one document at a time. Natural language processing (“NLP”) and similar document analytical tools can sometimes be applied to identify and locate themes and concepts within a single document.

However, such interconnected documents are usually employed holistically for business functions. For instance, an enterprise chief financial officer (“CFO”) may need to update a financial model for their enterprise. The specific source legal document for any particular constraint on that activity is not particularly meaningful to the business ends of the use case presented; rather, the CFO needs to comprehensively understand all of the legal constraints on the business activity of updating the enterprise financial model in order to effectively execute that activity in a manner that is legally compliant. The CFO could ask the enterprise legal department(s) for clarity, which would traditionally involve manual review of various legal documents, one at a time, to identify the many interconnected legal constraints affecting the proposed activity, including limitations and approval requirements. Multiple interrelationships can exist across a variety of interconnected legal documents within the enterprise legal environment even in such a simple scenario. Existing approach(es) fail to map those interrelationships in a way that reliably produces useful predictions or analysis across the entire suite of legal data.

### SUMMARY

Some aspects are directed to a server for data processing of unstructured data for presentation on a user device. The server is communicably coupled to a database server for storing the unstructured data and to the user device for consuming the unstructured data. The server includes at least one processor configured to receive the unstructured data from the database server, the unstructured data associated with an organization. The at least one processor is further configured to receive a specification of a construct including an organization structure associated with the organization for a function of the organization, the organization structure including a set of elements. The set of elements include one or more of a set of departments of the organization, a set of affiliates of the organization, or a set of authority entities of the organization. The construct further includes a set of fields associated with two elements of the set of elements, each field indicative of a mapping between its two elements. The at least one processor is further configured to populate the set of fields of the construct by mapping at least a first portion of the unstructured data based on the organization structure of the construct to generate an updated construct including a set of field entries. The at least one processor is further configured to convert the updated construct into a data interchange format file and receive, from the user device, a query for a second portion of the unstructured data that is subsumed by the first portion of the unstructured data. The at least one processor is further configured to convert, based on the query, a portion of the data interchange format file corresponding to the second portion of the unstructured data into response data, the response data including a specification of a visual display of the response data. The at least one processor is further configured to transmit, to the user device and responsive to the query, the response data, such that the user device renders the response data on a display of the user device based on the specification of the visual display.

Some aspects are directed to a method for data processing of unstructured data for presentation on a user device. The method includes receiving the unstructured data from a database server, the unstructured data associated with an organization. The method further includes receiving a specification of a construct including an organization structure associated with the organization for a function of the organization, the organization structure including a set of elements. The set of elements include one or more of a set of departments of the organization, a set of affiliates of the organization, or a set of authority entities of the organization. The construct further includes a set of fields associated with two elements of the set of elements, each field indicative of a mapping between its two elements. The method further includes populating the set of fields of the construct by mapping at least a first portion of the unstructured data based on the organization structure of the construct to generate an updated construct including a set of field entries. The method further includes converting the updated construct into a data interchange format file and receive, from the user device, a query for a second portion of the unstructured data that is subsumed by the first portion of the unstructured data. The method further includes converting, based on the query, a portion of the data interchange format file corresponding to the second portion of the unstructured data into response data, the response data including a specification of a visual display of the response data. The method further includes transmitting, to the user device and responsive to the query, the response data, such that the user device renders the response data on a display of the user device based on the specification of the visual display.

Some aspects are directed to a non-transitory computer-readable storage medium storing instructions for data processing of unstructured data for presentation on a user device. The instructions include instructions for receiving the unstructured data from a database server, the unstructured data associated with an organization. The instructions further include instructions for receiving a specification of a construct including an organization structure associated with the organization for a function of the organization, the organization structure including a set of elements. The set of elements include one or more of a set of departments of the organization, a set of affiliates of the organization, or a set of authority entities of the organization. The construct further includes a set of fields associated with two elements of the set of elements, each field indicative of a mapping between its two elements. The instructions further include instructions for populating the set of fields of the construct by mapping at least a first portion of the unstructured data based on the organization structure of the construct to generate an updated construct including a set of field entries. The instructions further include instructions for converting the updated construct into a data interchange format file and receive, from the user device, a query for a second portion of the unstructured data that is subsumed by the first portion of the unstructured data. The instructions further include instructions for converting, based on the query, a portion of the data interchange format file corresponding to the second portion of the unstructured data into response data, the response data including a specification of a visual display of the response data. The instructions further include instructions for transmitting, to the user device and responsive to the query, the response data, such that the user device renders the response data on a display of the user device based on the specification of the visual display.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed hercin that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a system for data processing and presentation.

FIG. 2 is a flow diagram depicting an example method for data processing and presentation.

FIG. 3 is a flow diagram depicting another example method for data processing.

FIG. 4 is a flow diagram depicting another example method for data processing.

FIG. 5 illustrates an example construct.

FIG. 6 illustrates another example construct.

FIGS. 7A-7E are example renderings of a governance pathway for an example update to a project lifecycle financial model, on a desktop/laptop device.

FIG. 7A illustrate a stakeholder map that shows all enterprise entities and third party stakeholders. The map of FIG. 7A can generally be considered a reference map/diagram for all animated displays that can be generated from a given construct.

FIG. 7B illustrates a first stage/step of the animated display of FIG. 7A.

FIG. 7C illustrates a second stage/step of the animated display of FIG. 7A.

FIG. 7D illustrates a third stage/step of the animated display of FIG. 7A.

FIG. 7E illustrates a fourth stage/step of the animated display of FIG. 7A.

FIG. 8 is an example rendering of the governance pathway of FIGS. 7A-7E, rendered on a mobile device.

FIGS. 9A-9E are additional renderings of the governance pathway of FIG. 7E. Specifically, FIG. 7E provides a starting point for a deeper dive of visual representation of the information in the construct to show the specific pathways at the level of individual officers and directors of each of the entities shown in FIG. 7E.

FIG. 9A illustrates a first stage/step starting with the animated display of FIG. 7E, and illustrates an entity level zoom-in on the organizational structure of each of the three companies in the pathway from FIG. 7E.

FIG. 9B illustrates a second stage/step starting with the animated display of FIG. 7E, and illustrates how the peripheral entities shown in FIG. 9A fade away. A user would have clicked on the TopCo Icon to zoom in to this next level of detail.

FIG. 9C illustrates a third stage/step starting with the animated display of FIG. 7E.

FIG. 9D illustrates a fourth stage/step starting with the animated display of FIG. 7E. Generally, FIGS. 9C, 9D illustrate that the individual approvers are all now deconstructed and placed in sequence according to their specific role in the governance pathway.

FIG. 9E illustrates an interface that is displayed when a user clicks on the ‘check my work’ button in the interface of FIG. 9D, and provides a listing of source documents associated with that portion of the pathway.

FIG. 9F illustrates an interface that is displayed when a user clicks on one of the source documents in FIG. 9E.

FIGS. 10A-10C are additional example renderings of the governance pathway of FIG. 9D.

FIG. 10A illustrates a first stage/step starting with the display of FIG. 9D, after a user clicks ‘initiate new approval’ to start that workflow.

FIG. 10B illustrates a second stage step starting with the display of FIG. 9D, and illustrates a financial model that has been uploaded by a user (the CFO, Chief Financial Officer) to initiate and endorse the approvals on the pathway for that activity.

FIG. 10C illustrates a third stage step starting with the display of FIG. 9D, and illustrates an example interface that is displayed after the user clicks ‘submit’ on the display of FIG. 10B, resulting in the approval processing being initiated, endorsed, and transmitted to the next user in the workflow for review approval.

### DETAILED DESCRIPTION

All combinations of the foregoing concepts and additional concepts are discussed in greater detail below (provided such concepts are not mutually inconsistent) and are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

Following below are more detailed descriptions of various concepts related to, and implementations of, systems, devices and methods for data processing and presentation. It should be appreciated that various concepts introduced above and discussed in greater detail below may be implemented in numerous ways. Examples of specific implementations and applications are provided primarily for illustrative purposes to enable those skilled in the art to practice the implementations and alternatives apparent to those skilled in the art.

The example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

### Overview

Aspects disclosed herein are generally directed to analysis of interrelated documents. Deficiencies with conventional approaches, which typically search one document at a time for helpful clues, are overcome by the methods disclosed herein by mapping all the interconnections by relevant function within the structured construct (like the example construct 500) described herein. Those mappings can be used to sequence the steps required to navigate the network of interconnections across the enterprise legal document architecture, which in turn can provide legal and business leaders with real time answers to enterprise governance and legal questions. Extracting such data from the source documents can be used to create a database of business functions, definitions, and corresponding proprietary coding/mapping that allows one to apply NLP, behavioral analytics, and other AI tools to process all legal constraints at once, rather than one document at a time. By structuring the data according to the methods and innovations described herein, one can subsequently reliably apply AI and document processing tools to obtain insightful data and predictive outcomes across the interconnected suite of documents.

As such, aspects of the systems, devices, and methods disclosed herein are generally directed to populating constructs by accessing and mapping voluminous, interconnected, and unstructured data (e.g., legal documents) to the structured format described herein (the “construct”, such as the example construct 500). Generally, unstructured data may be considered any data that is not organized in a pre-defined manner, such as according to a data model. Examples of unstructured data are text in document files. An example of structured data is data that is found within fixed fields and columns of a relational database or a spreadsheet.

The populated construct is then transformed into structured data, and that is in turn usable by various machine learning and artificial intelligence algorithmic processes for analytics. In some cases, the systems, devices, and methods disclosed herein can encompass processing data from a host database on an Enterprise Resource Planning (“ERP”) or similar server to populate a construct, i.e., converting the data into an intermediate format that is compatible with an organizational construct that renders the data as a structured array of binary data. This binary data can be employed for forward processing to generate converted data, which can be communicated to user devices (e.g., desktop computers, tablets, mobile devices, and/or the like). In some embodiments, a host application access application (described in greater detail below) executing on a first server performs interface operations with an ERP or similar database server.

In some embodiments, the unstructured data is converted into a structured dataset on the first server. In some embodiments, a native client for computer and/or mobile devices renders the converted data according to multiple rules.

By way of illustration, consider the following example of how underlying legal data and/or documents related to the business function of updating a financial model are mapped to a construct, which in turn is transformed and ultimately employed to be visually rendered to a user responsive to one or more queries from the user.

### Example Construct and Operation

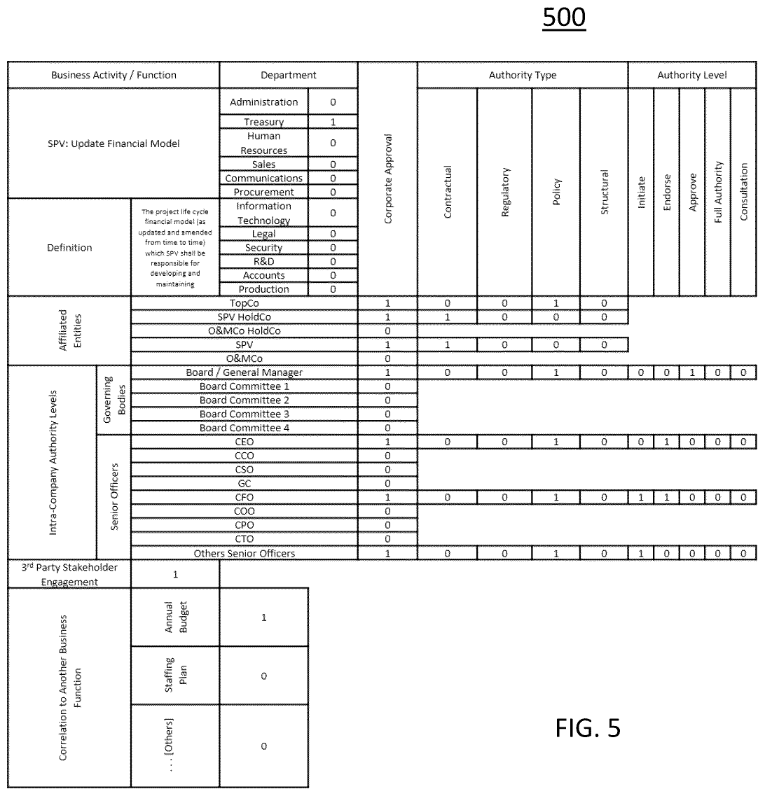

FIG. 5 illustrates an example construct 500 which can generally be considered a structured data representation of an enterprise structure, though it is understood that the construct can be representative of any structured entity . Consider that via consultations, the enterprise structure, including intra-enterprise relationships, has been generated, say according to governance trees. The enterprise structure can encompass organizational structures which includes governing bodies, individual senior officers, business functions, department associations, and/or the like. In the example construct 500, the organization has twelve departments (as listed in the figure under the heading “Department”), five affiliated enterprise entities as listed in the cells to the right of “Affiliated Entities”, and within each enterprise affiliate the boards, governing bodies and senior officers listed to the right of “Intra-Company Authority Levels”. Depending on a particular enterprise environment, additional permutations of “Authority Types” and “Authority Levels” could be a part of a construct.

The construct can identify external stakeholder correlations, and correlations to other business functions for a particular user. While disclosed herein for a single business function, the 2D array of the construct 500 can be multiplied/replicated in a third dimension to accommodate tens, hundreds, or even thousands of business functions that are mapped to the construct 500, each having its own array of specific binary outcomes against the construct 500 based upon the underlying data sources (e.g., legal text in underlying legal documents).

As explained in greater detail herein, the example construct 500 also illustrates the binary mapping (represented here as entries of ‘1’s and ‘0’s) of analysis outcomes for a single business activity or function. Here, the business function is to update the financial model at the level of the enterprise company denominated by “SPV”. A definition is provided by extracting appropriate descriptions from the enterprise's (source) legal documents, as described below.

The example construct 500 can be populated based on source legal text associated with the enterprise. The mapping of clauses from the legal texts to the binary entries/outcomes in the construct 500 can in some cases be done manually. In some cases, the mapping can be done manually but aided by machine learning approaches such as, for example, neural networks. For example, by employing the manual mapping as training data, the machine learning approach(es) can gradually experience/have enough training data to automatically populate the construct on a per-business function basis with predictive binary entries/outcomes based on source legal text. As a result, data representing the mapping/correlation of each clause mapping to each binary outcome in a particular cell of the construct can be captured for purposes of both training the neural network and also allowing users to interact with the software interface to quickly identify and open source documents from an ERP or other database server (described later) where relevant to the authority types that are mapped to specific business functions in the construct (thereby reducing processing requirements in sending queries to the server hosting the SaaS application and also in identifying and retrieving only those source documents which are necessary for further analysis and verification). In some cases, the mapping can be done substantially or completely by machine learning, such as by a trained neural network.

For purposes of explaining the mapping of legal text to binary entries of the example construct 500, consider the following clauses. From a Shareholders' Agreement document:

Based on the clauses from the source legal texts above, the construct 500 can be populated as follows. For example, the text from the Shareholders' Agreement and the Delegation of Authority relate to the financial model, the updating of which is the simple use case presented by way of example herein. The text further specifies that “SPV” is directing the actions in the first instance. This leads to a “Governance Array” of binary values for the activity “SPV: Update Financial Model”, as shown in the example construct 500 of FIG. 5. Based on input (e.g., from the customer and/or other knowledge), this activity can be linked to the Treasury Department, leading to assignment of a value of “1” to the corresponding cell in the construct 500.

Further, the text of the Shareholders' Agreement specifies that the Approval of the Major Shareholders is required. Analysis of the definition of “Major Shareholders” in the source document indicates that “SPVHoldCo” is a required approver; therefore, the cell in the Governance Array corresponding to “Corporate Approval” of the “Affiliated Entity” (“SPV HoldCo”) is assigned a value of “1.” Because the Shareholders' Agreement is a contract existing among Enterprise Entities, the cell in the Governance Array corresponding to “Contractual”under “Authority Type” for the “Affiliated Entity” (“SPV HoldCo”) is assigned a value of “1”.

Now consider that the Delegation of Authority is an SPV-level policy document, and the text of the Delegation of Authority is located in a section of the document specifying “CEO” responsibilities to prepare or cause the preparation of the financial model for approval by the “BoD” (i.e., the board of directors). Therefore, the cell in the construct 500 corresponding to “Corporate Approval” of the “Governing Body” (“Board/General Manager”) is assigned a value of “1”, corresponding to the requirement of board approval at the SPV level. Similarly, the authority level “Approve” is assigned a value of “1”. Because the Delegation of Authority is a policy document, the cell in the Governance Array corresponding to “Policy” under “Authority Type” for the “Governing Body” (“Board/General Manager”) is assigned a value of “1”. All legal text is similarly categorized as described herein, and all cells without an assigned value are assigned a value of “0”.

Once the construct 500 is populated for all business functions (including the “Update Financial Model” business function) to be mapped, NLP can be applied to the business functions and definitions set out in the tens, hundreds or thousands of constructs so generated, and the binary outcomes then (for example) drive an engine to generate visualizations, including animated visualizations, at the user interface level that can be used to answer user queries of the business functions, as described herein.

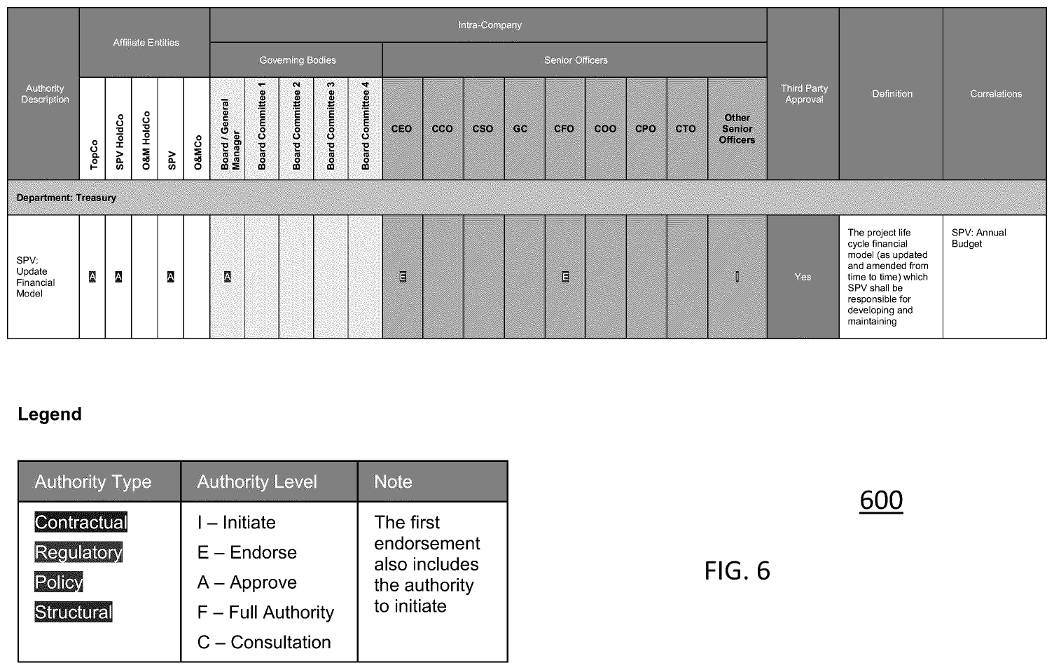

FIG. 6 illustrates another example construct 600 which is a different layout of the same example construct 500 for the same business functions described for FIG. 5.

### Example System for Data Processing and Presentation

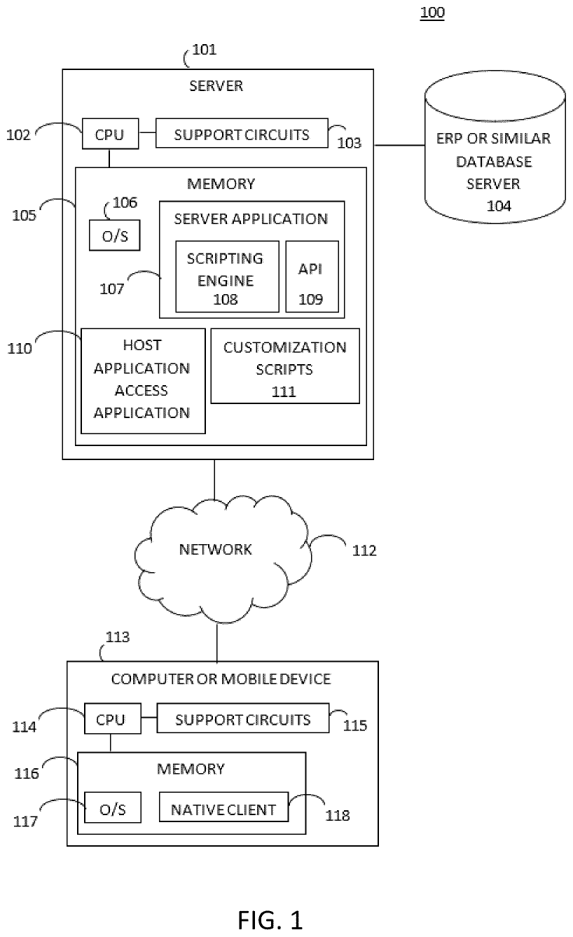

FIG. 1 is an example, schematic illustration of a system/ecosystem 100 within which aspects of the disclosed approaches operate, and that includes a server 101 that is couplable to a user device 113. The system 100 can encompass interfaces provided by the server 104 for the device 113 in order to access voluminous, interconnected and unstructured data (e.g., legal data, such as in legal documents), and to convert that data into a structured data set (e.g., such as the example constructs 500, 600). In some embodiments, the system 100 includes the server 101, an ERP or similar database server 104, a network 112, and a computer or mobile device 113. The server 101 exchanges data with the server 104, during which the server 101 pulls and converts such data to an intermediate format as described in detail herein in accordance with the other embodiments described herein. The server 101 also receives user requests for information based on the converted data (in the intermediate format), such as from the user device 113, and then sends/transmits renderings of the converted data to the user's computer or mobile device 113 via the network 112 according to pre-defined rules as described herein.

The server 101 includes at least a processor/CPU 120 and a memory/database 105. Unless indicated otherwise, all components illustrated within the server 101 can be in communication with each other. It will also be understood that the database and the memory can be separate data stores. In some embodiments, the memory/database 105 can constitute one or more databases. Further, in other embodiments, at least one database can be external to the server 101. The server 101 can also include one or more input/output (I/O) interfaces (not shown), implemented in software and/or hardware, for other components of the system 100, and/or external to the system 100, to interact with the system.

The memory/database 105 can encompass, for example, a random access memory (RAM), a memory buffer, a hard drive, a database, an erasable programmable read-only memory (EPROM), an electrically erasable read-only memory (EEPROM), a read-only memory (ROM), Flash memory, and/or so forth. The memory/database 105 can store instructions to cause the processor 102 to execute processes and/or functions associated with the server 101 and/or the system 100.

The database 105 can store any suitable content for use with, or generated by, the system 100. The processor 102 can be any suitable processing device configured to run and/or execute a set of instructions or code associated with the system 100. The processor X can be, for example, a general purpose processor, a Field Programmable Gate Array (FPGA), an Application Specific Integrated Circuit (ASIC), a Digital Signal Processor (DSP), and/or the like.

In some embodiments, all components of the server 101 can be included in a common casing such as, for example, a single housing that presents the server 101 as an integrated, one-piece device for a user. In other embodiments, at least some components of the server 101 can be in separate locations, housings, and/or devices. For example, in some embodiments, the memory/database 105 can be in a separate housing from the processor 102 and be in communication via one or more networks, each of which can be any type of network such as, for example, a local area network (LAN), a wide area network (WAN), a virtual network, a telecommunications network, and/or the Internet, implemented as a wired network and/or a wireless network. Any or all communications can be secured (e.g., encrypted) or unsecured, as is known in the art. The server 101 can be or encompass a personal computer, a server, a work station, a tablet, a mobile device, a cloud computing environment, an application or a module running on any of these platforms, and/or the like.

As illustrated, the server 101 can include various support circuits 103 to facilitate the operation of the processor 102 and include such circuits as clock circuits, power supplies, cache, input/output circuits and devices, and the like. The memory 105 can also store executable (by the processor 102) code for an operating system 106, a server application 107, and a host application access application 110. In operation, the processor 102 executes the operating system 106 to control the general utilization and functionality of the server 101.

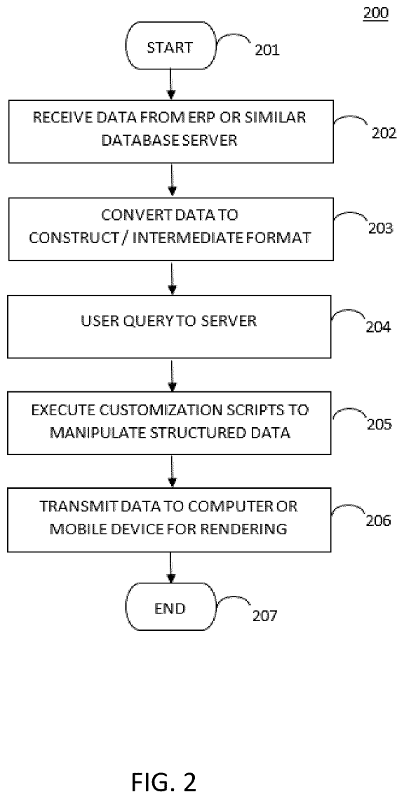

The memory 105 can store computer-executable instructions (e.g., executable by the processor 102) for a server application 107. The server application 107 converts data to an intermediate format suitable further processing within the application 107 and for generating information for display on user computers and mobile devices 113, all as more particularly depicted and described in FIGS. 2-4 and the associated descriptions, and as explained for the Example Construct above. In some embodiments, the server application 107 communicates with user devices via the hyper-text transfer protocol (“HTTP”), but one of ordinary skill in the art would recognize that other application layer protocols such as telnet, secure socket layer, rlogin, and the like could be used in addition or alternatively. The server application 107 converts data received from the host application access application 110 into an intermediate format suitable for further processing and to send to user computers and mobile devices 113.

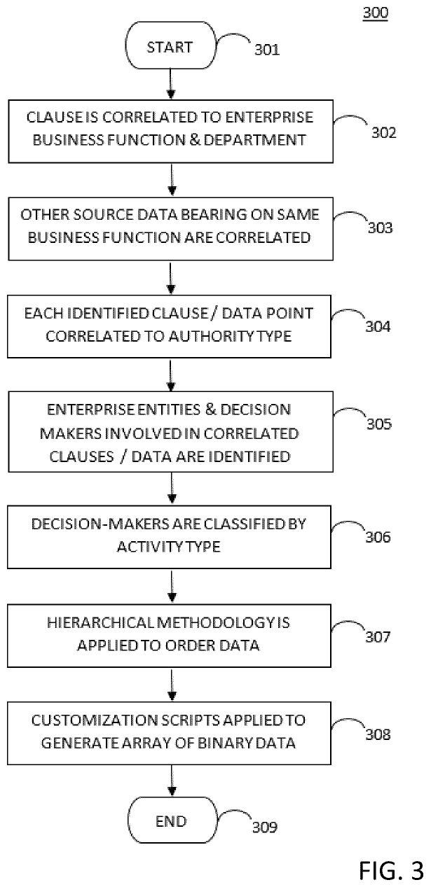

In some embodiments, the server application 107 includes a scripting engine 108 with a scripting environment/application programming interface 109 that executes one or more customization scripts 111. These customization scripts 111 translate the data, as structured according to the method depicted and described at FIG. 2, into an array of binary data (e.g., in the example construct 500) conveying relevant information from the structured data for display as animated renderings over the device interface via the native client 118. For instance, the array of binary data structured according to the method depicted and described at FIG. 2 and FIG. 3 presents a pattern of enterprise governance actions, decision-makers, authority types, enterprise affiliates, etc. that are sequenced in such an array. Binary outcomes on that array may be populated according to a classic combinatorics equation, thereby presenting as a finite number of choices from the underlying unstructured data set. Those finite choices can then each drive a particular animated visual that represents an answer to a user's specific governance query submitted to the server 101 from the user's computer or mobile device 113.

For example, consider that the Governance Array/construct 500 in the example described herein presents 9.671406556917e+24 permutations (n=2; r=83). While that is a very large number, it is not infinite. By structuring the data as described herein, a construct of finite possibilities can be generated. Said another way, a construct as described herein can pre-define a bounded universe of all governance pathways for any conceivable governance problem faced by the organization. The inventors have postulated that the number is enormous but not infinite, and one can mathematically model the entire universe according to the construct. Accordingly, the pathways are animated based on the governance construct in the example herein, and there would be 9.671406556917e+24 possible animations that could render for any specific user query. In this manner, any time the organization considers a new business function, assuming it has unlimited discretion to choose a pathway, users such as business leaders can consider a total universe of 9.671406556917e+24 possible ways to take the issue forward and create a pathway. Practically, many of those will be eliminated by virtue of pre-determined constraints, but this can nevertheless be useful to users for “dashboard deal-making”. Practically, once the neural network has been sufficiently trained, it will be able to start predictively selecting and suggesting possible solutions from the large but finite set of choices. If those choices also are correlated to underlying legal text, a user could select a pathway from among the options the neural network suggests when there is a new issue to confront. In some cases, along with the underlying data, aspects disclosed herein can also be configured to present variations of source text that drive those outcomes. Accordingly, users can quickly be presented with pathways, illustrative source text, and suggested solutions with one or more animated visuals, and also be presented with documentation to drive that pathway/solution.

The memory 105 further comprises code for executing a host application access application 110. The host application access application 110 is a front end for the server 104, and can provide access to the data and/or functionality provided by the server 104. The application 110 sends and receives commands and data to and from the server application 107 in an application server specific format. Said another way, the data and combinatorics approach(es) disclosed herein can drive the scripting engine 108 that executes one of the possible 9.671406556917e+24 animations based on a user query, without having to analyze the underlying source text/data. The source data will still be identified, but it does not require intensive processing to respond to user queries. This, in turn, conserves processing power and time.

In some cases the server 101 can be configured to provide governance and/or legal enterprise management functionality that interfaces with the server 104 via host application access application 110. The server 101 also processes commands within its own environment allowing the user (e.g., of the device 113) to access data, execute programs, generate reports, and various other data access and integration tasks, data from which actions may be sent to the ERP or similar database server 104 via a scripting environment/application programming interface (API) 109.

The user device 113 can include a desktop a laptop computer, or a mobile device (e.g., personal digital assistant, mobile phone, smart phone, computer tablet and the like). One or more native applications can reside on the user's computer or mobile device 113 to render data received from the server application 107 on the device, to wait for data entry, to take into account interruptions inherent in device interface, to perform session continuation after such an interruption, and the like.

The user device 113 can be comprised of a CPU 114, support circuits 115, and a memory 116. The CPU 114 may comprise one or more microprocessors or microcontrollers that facilitate data processing and storage. The various support circuits 115 are utilized to facilitate the operation of the CPU 114 and include such circuits as clock circuits, power supplies, cache, input/output circuits and devices, and the like. The memory 116 may comprise random access memory, read only memory, removable storage, optical disk storage, disk drive storage, and combinations thereof. The memory 116 stores an operating system 117, and a native client 118. In operation, the CPU 114 executes the operating system 117 to control the general utilization and functionality of the computer or mobile device 113.

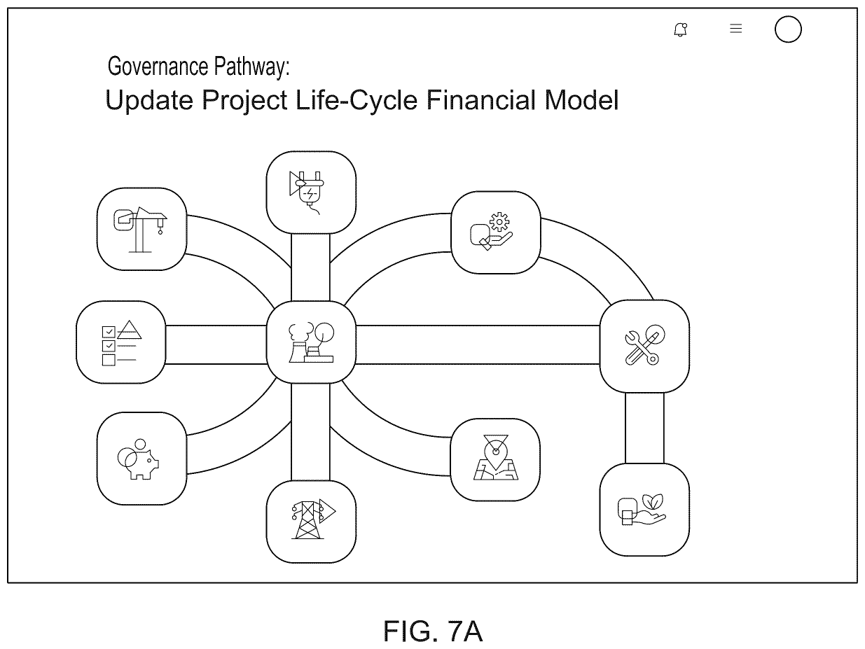

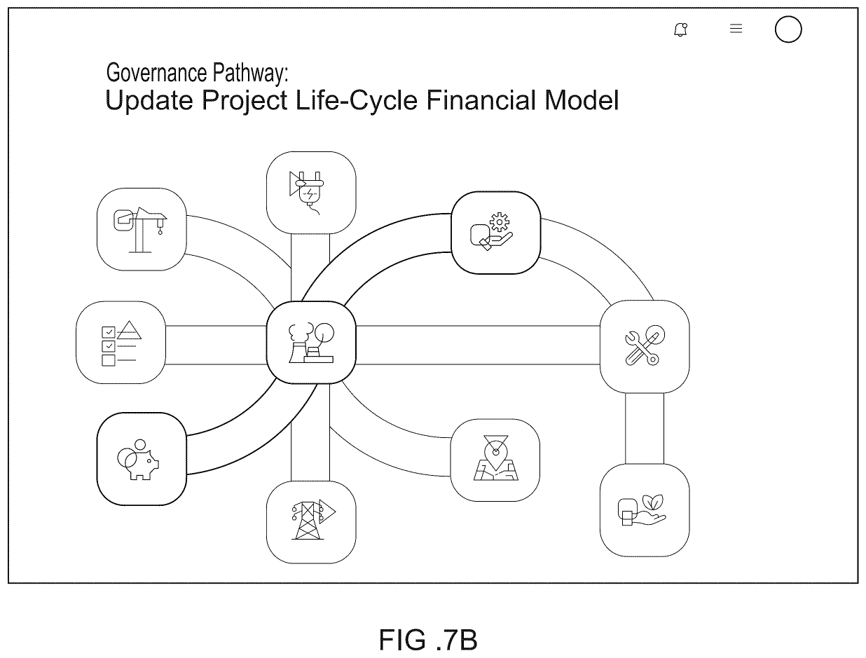

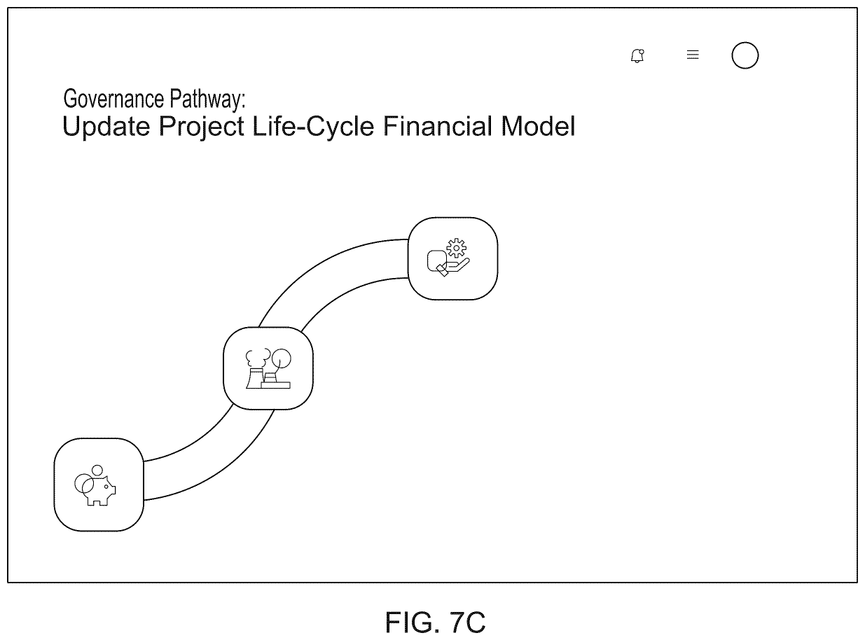

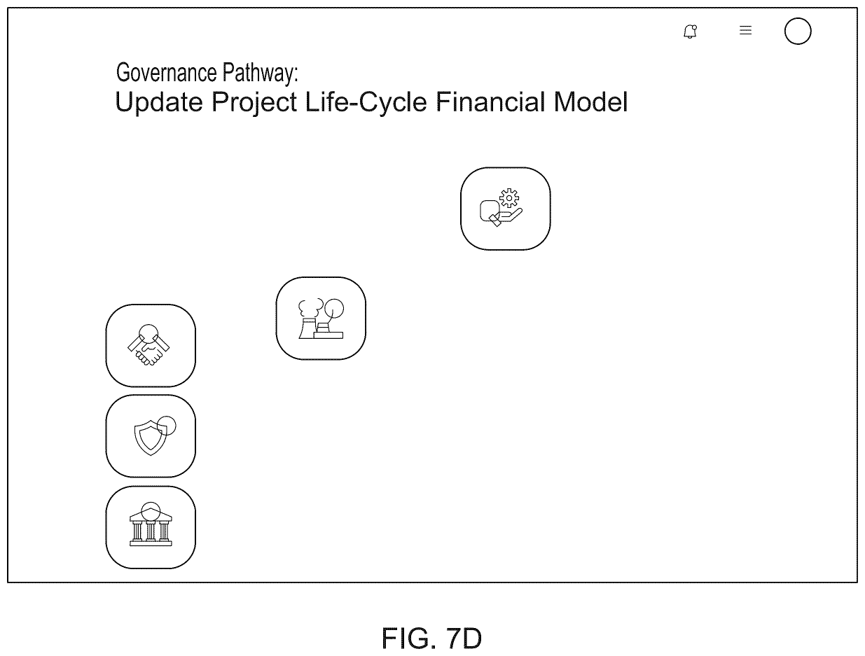

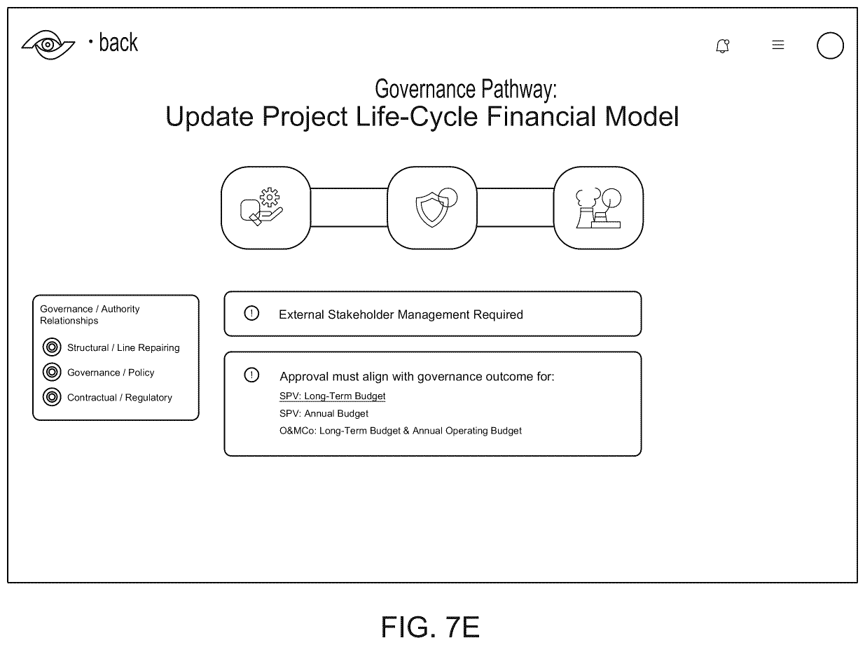

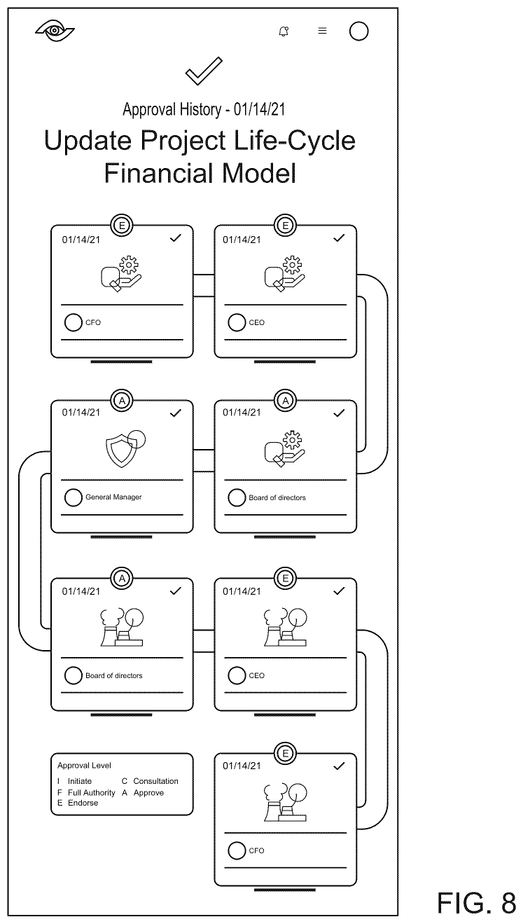

The memory 116 also comprises executable code for a client 118, which can be, in some cases, a native client that can properly render the visual elements (as described herein) across different device formats (e.g., desktop a laptop computer, or a mobile device). The native client 118 can allow a user to access the server 101 by sending and receiving data and commands to and from the server application 107. In some embodiments, the server application 107 alters data sent to the device 113 to a format specific for the interface provided by the device 113. In some embodiments the native client 118 may execute a series of rules that provides the best interpretation of data sent by the server application 107. As an example, rows of icons showing governance flows might be automatically converted into a snaking pattern when rendered on a mobile device 113. Depending on the customization scripts 111, the native client 118 will render the screen and enable navigation that is native to the computer or mobile device 113. The native client 118 may also utilize an efficient state driven polling loop that utilizes standard HTTP through the network 112. Various native clients 118, tailored for the individual computer or mobile device 113 using custom script interpretations, enable a single version of a customization script 111 to be utilized across a variety of types of computer and mobile devices 113. FIGS. 7A-7E are example renderings for a desktop/laptop computing device, and FIG. 8 illustrates an example rendering for a mobile device.

FIG. 2 is a flow diagram depicting a method 200 for converting voluminous, interconnected and unstructured data (e.g., legal clauses in legal documents) accessed by the system shown in FIG. 1 into structured data against which artificial intelligence and machine learning approaches may be applied to generate more usable and reliable results in accordance with the embodiments of the present invention. The method begins at step 201.

At step 202, unstructured data (e.g., legal documents) is received from the ERP or similar database server 104. In some embodiments, this data is received via the host application access application 110 and sent to the server application 107. Such data is typically in a customary document format (such as .pdf or .docx, but generally extendible to text file and/or other formats) as specified according to the server 104 environment and the host application access application 110. In some embodiments, the server application 107, either manually or according to artificial intelligence/machine learning approaches aided by manual training, extracts the data via an interface provided by the host application access application 110, such as using NLP and reading values contained within text fields in the source unstructured data in the host application access application 110, and/or using other methods. Consider that NLP is used to predict correlation between the text and the “1”s and “0”s in the construct. The construct can be considered static, though it is understood that the construct can be manually modified and/or modified via suitable machine learning approaches. With the construct remaining static, machine learning processes, such as neural networks described herein, can I apply statistical models to correlate whether text in the data is likely to be mapped with a value of “1” or “0” to any particular cell of a construct. Aided by manual training, the neural network can learn which language corresponds with which outcomes, particularly in terms of correlating the flow of text and key words (e.g., “BoD” or “Board”) with positive “1” values in certain cells. Once the data has been extracted and/or received, the method proceeds to step 203.

At step 203, the server application 107 parses and converts the data into a structured format (the “construct”, such as the example construct 500). The construct can generally be considered a representation of an organizational structure, into which voluminous, interconnected and unstructured data are ordered and populated according to a user's specific enterprise environment. For example, those data are extracted and populated according to enterprise business function, enterprise affiliate entity, source legal authority type and decision-maker authority type, all defined and sequenced according to specified rules matched to the enterprise philosophical approach to governance as reflected in underlying legal documents.

The specific format of the processed and organized data as represented in the construct is then converted to an intermediate format, which may include JavaScript Object Notation (JSON) or Extensible Markup Language (XML), and/or any serialized representation, and in all cases presents as a sequence of binary format data ordered according to the construct structure, such as can be implemented differently for each different enterprise environment. Translating the unstructured data into this intermediate array/format of ordered values in binary format can be beneficial for eliminating the necessity for the end user to directly access and translate the unstructured data (e.g., the underlying legal files) on the server 104 from the host application access application 110 specific format, a task that traditionally involves a significant amount of processing power and (where artificial intelligence is involved) a tremendous amount of data trials to produce reliable results. Practically speaking, the construct is the amalgamation of functions, definitions and Governance Arrays associated with each function and definition. If the construct is the conceptual structuring of the data, then the intermediate format is useful for providing a consistent way to represent those arrays/constructs such that the visualization scripts described herein can act on them. Once the data/construct is translated to the intermediate format, the method proceeds to step 204.

In some embodiments, the server application 107 processes the newly structured data/data stream of source data from the ERP or similar database 104 and recognizes the structured data. For example, the server application 107 parses the binary data stream into intermediate format (e.g., JavaScript or others) objects by identifying specific markers that signify each new object, such as the population of the Governance Arrays in relation to specific entities, governing bodies, authority types, etc. The objects are suitable for transmission to computers and the mobile devices 113 because such objects are compatible with native device applications that can render information derived from the underlying data as simple-to-understand animations. The server application 107 can builds data structure (e.g., arrays or trees based on the construct as populated with source data from the ERP or similar database) that stores a list of the JavaScript objects. As an example, each of the JavaScript objects may include enterprise and authority type information derived from the unstructured legal data in the form of attributes (i.e., keys), such as enterprise business function, enterprise affiliate entity, source legal authority type and decision-maker authority type, all defined and sequenced according to specified rules matched to the enterprise philosophical approach to governance as reflected in underlying legal documents, all having values of various data types.

At step 204, the server receiving a query from a user in relation to the structured construct data such as via the network 112, at the server application 107. For example, in the example presented herein, a CFO may input a query into a search bar of the client 118 to the effect of “what approvals do I need to update the financial model?”. The method then proceeds to step 205.

At step 205, in response to the specific user query as processed by the server application 107, the script engine 108 executes customization scripts 111 that manipulate the structured data in the intermediate format (e.g., JSON, XML, and/or the like) to alter and optimize the user interface that will eventually be presented on user computer or mobile devices 113 according to some embodiments. For example, the user query can include search bar-type queries that feed an NLP process which is run against the list of business functions and definitions in the construct. Once the right function is selected, the associated binary outcomes in the combinatorics model can drive the answers in the form of animated displays on the user device(s). These customization operations may include rendering the data for the response as animated responses to user prompts as received by the server application 107.

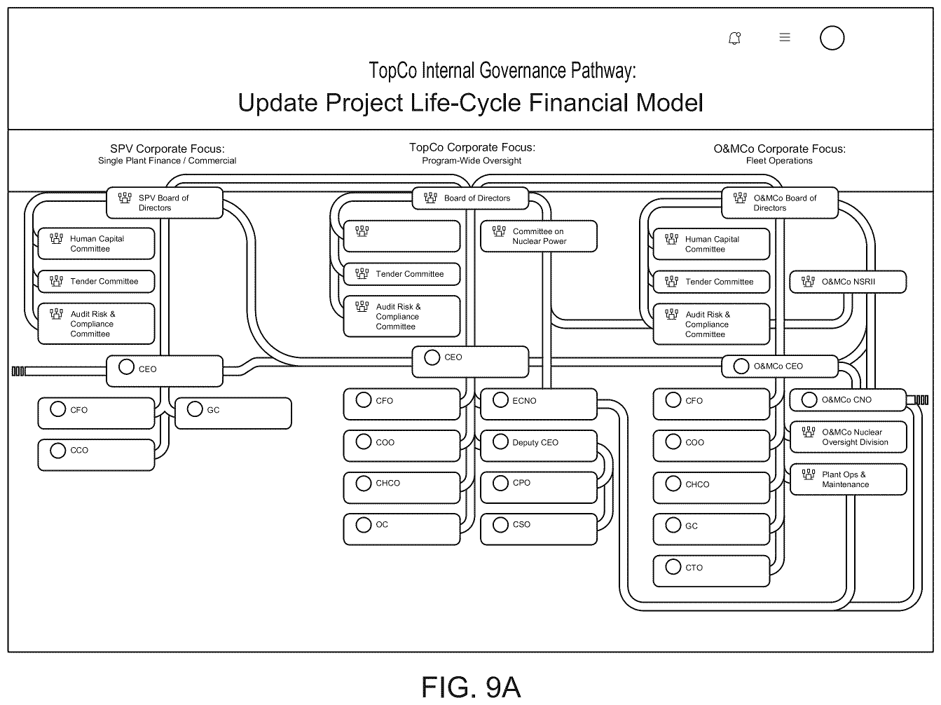

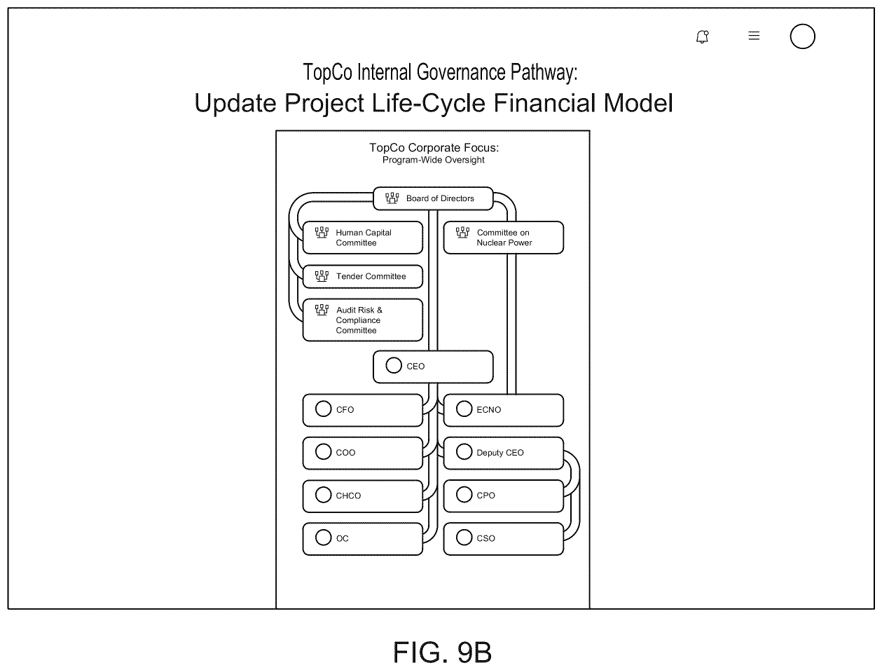

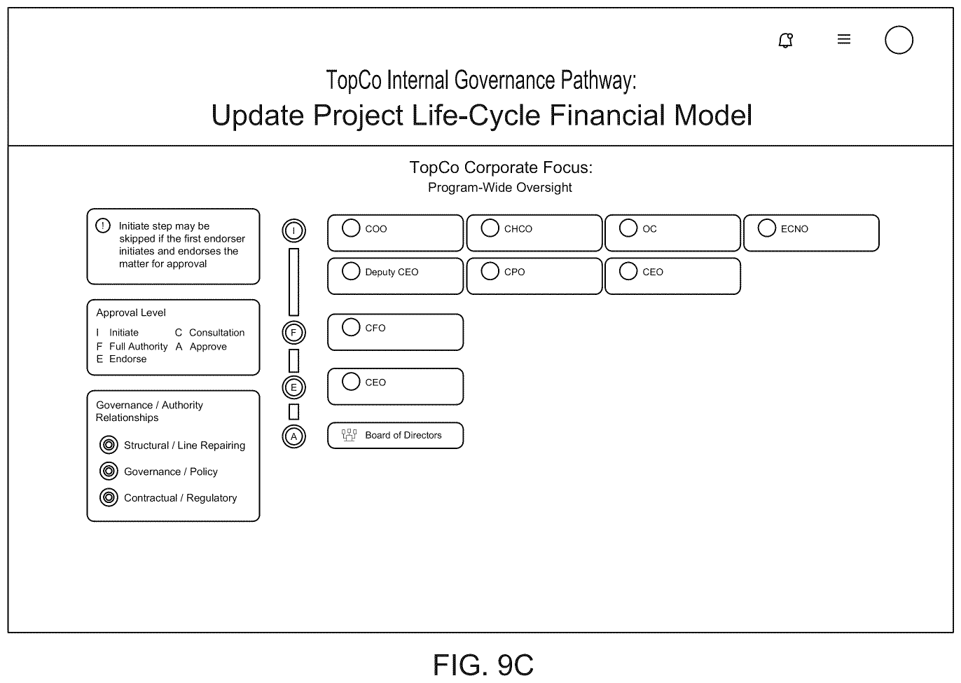

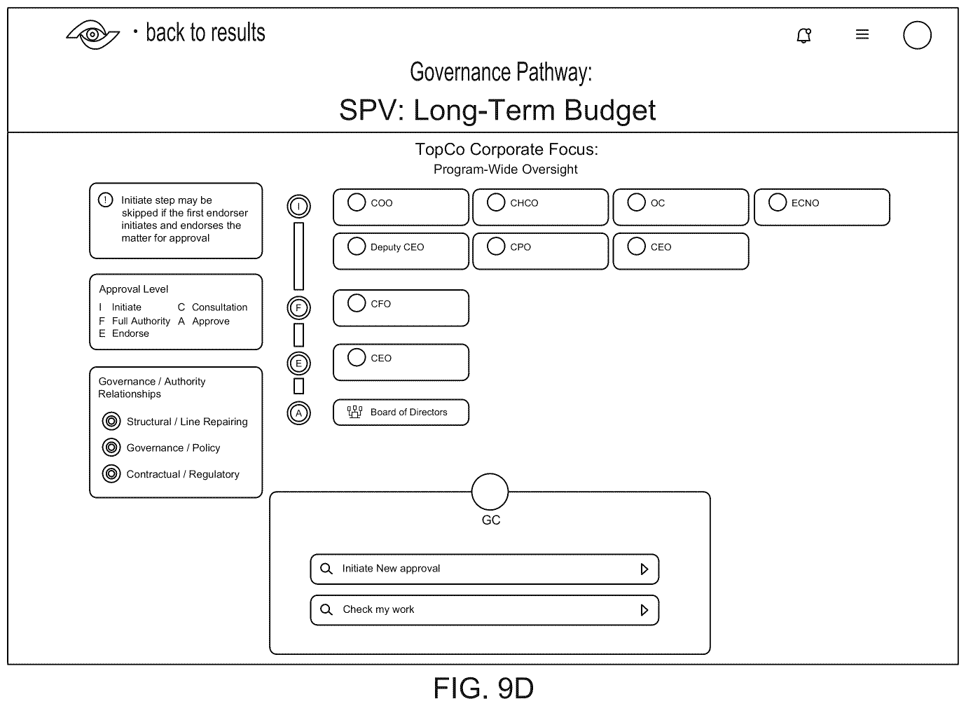

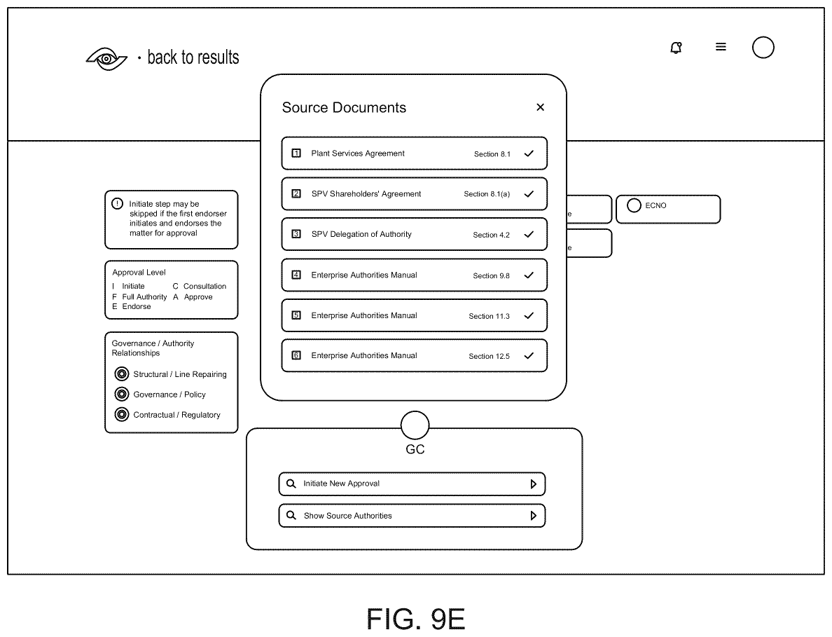

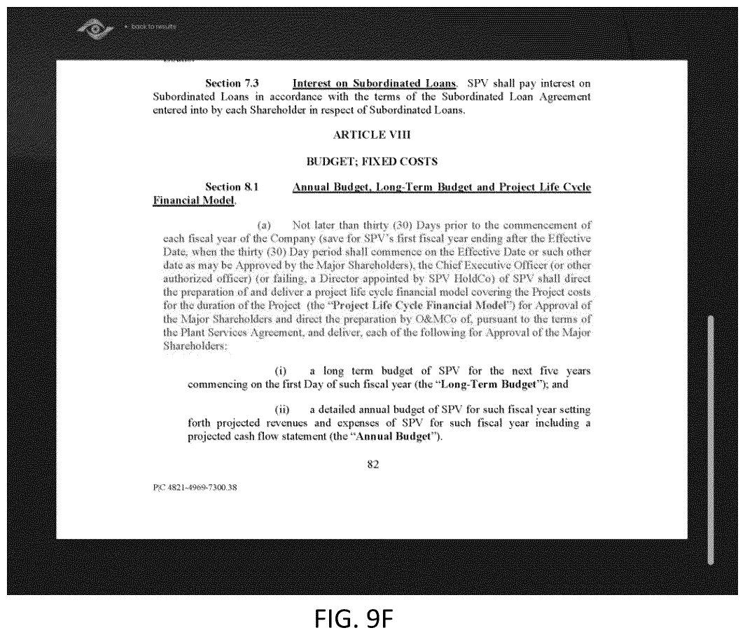

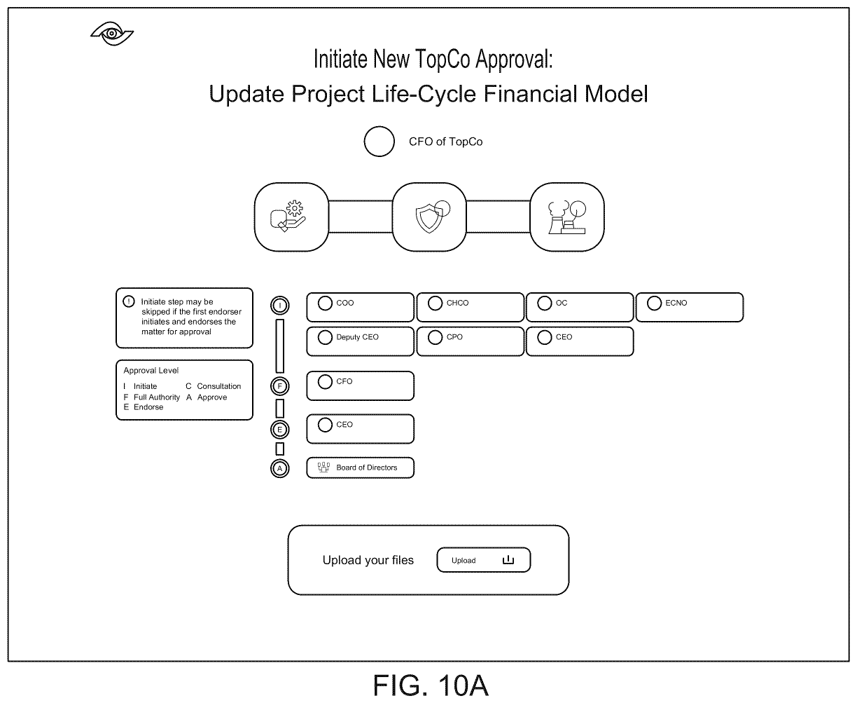

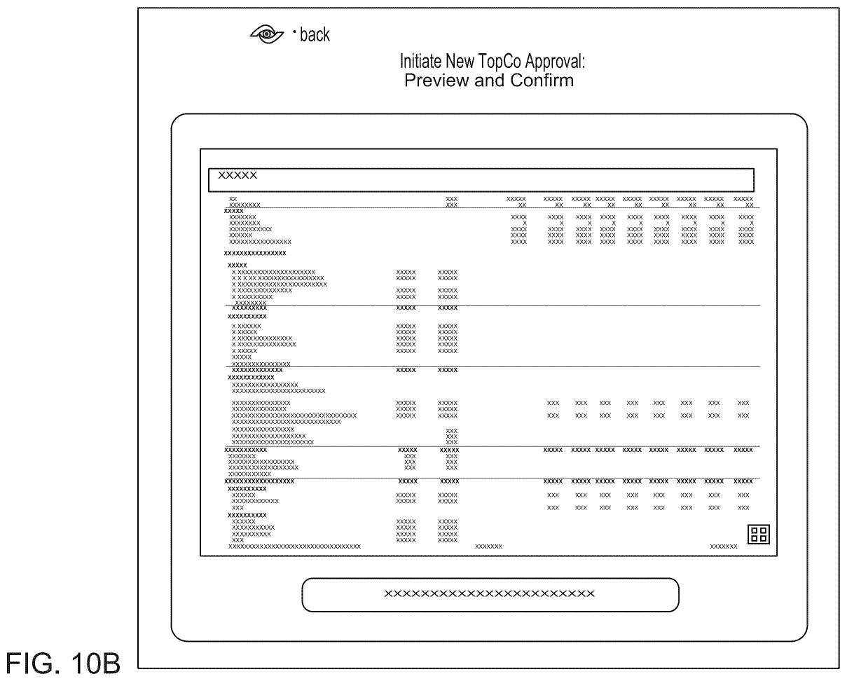

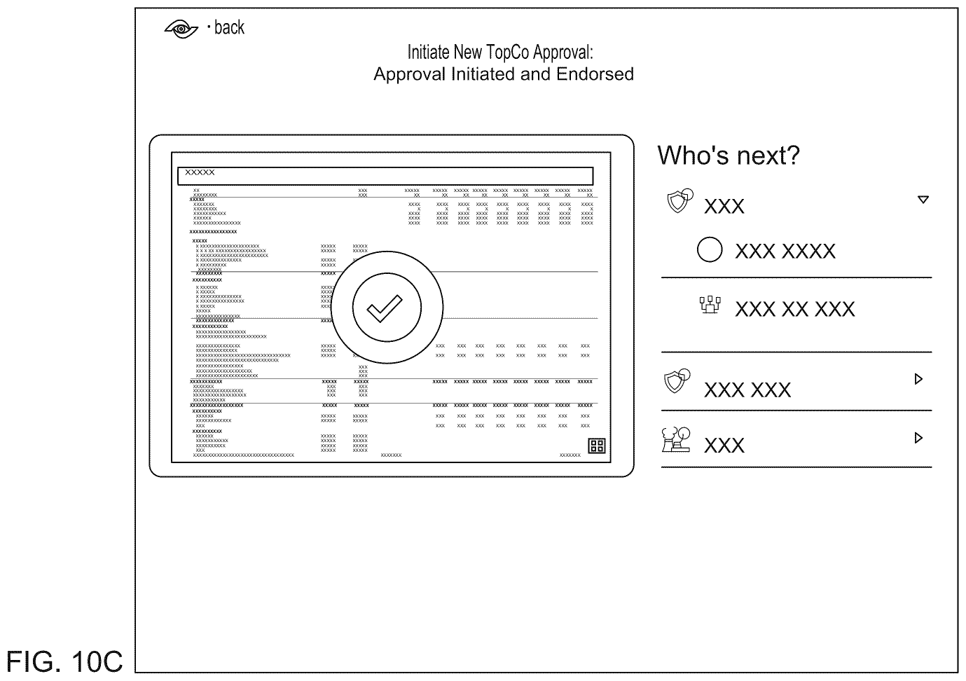

The customization scripts 111 can be executable to extract text fields from underlying source (e.g., legal document) data that have been identified as bearing on outcomes and data captured by the construct. As noted above, the animated answers are all driven from the construct without any need for diving into the source data, but users will still have captured all those correlations when the construct is mapped. Therefore, with relatively reduced processing power, users can still flag those correlations and pull up the source text for verification. Because the mapping is already identified and the correlations are stored as capture data when the construct is populated, the corresponding source document and text can immediately be retrieved. These extracted data fields can be displayed in full expanded detail from the user computer or mobile device 113 if desired (i.e., clicked to show source authority). For example, governance data transmitted to a user computer or mobile device 113 in response to a user query for governance information, and rendered as an animated governance pathway, include lists showing the correlated source legal data (e.g., document and clause reference) contributing to the rendering, which lists can be clicked and expanded to show the relevant source clause as well as the full source document (as taken from the ERP or similar database server 104). Sec FIGS. 9A-9F. Action items may be used to select the specific item and/or initiate workflows based on the information presented. See FIGS. 10A-10C. In some embodiments, the customization scripts 111 also determine sequencing of endpoints to the animated results and corresponding data fields and action items on a display screen.

At step 206, the server application 107 transmits the converted data (i.e., the structured data converted by the customization scripts) to the computer or mobile device 113 to be rendered as an animated result. While in the present example the server application 107 is discussed as transmitting the data, one of ordinary skill in the art would recognize that a separate web server executing on the server 101 or another networked computer would also be able to perform the same task. In some embodiments the server application 107 transmits the converted data via HTTP. In some embodiments, the server application 107 may perform additional translation functions depending upon the type of device to which the data will be transmitted. The method ends at step 207 when the data has been transmitted.

FIG. 3 is a flow diagram depicting a method 300 for reclassifying voluminous, interconnected and unstructured legal data processed into the construct as shown in FIG. 5 and described in FIG. 2 in order to create a structured array of binary data which is then used to generate more usable and reliable results in accordance with the embodiments disclosed herein. The method begins at step 301.

At step 302, a particular clause of identified data (e.g., legal text) is classified by correlations it has to a defined list of enterprise business functions, broken out by department. Generally, the finite choices determined by the computational approaches described herein can be used to set up a series of animations based on the combinatorics of the construct and the finite number of permutations for each business function. The population of the Governance Array/construct with “1”s and “0”s corresponds to the choices from among the permutations, and each potential combination can have an associated animation. Those choices among the permutations are communicated between the server and the user device in any suitable manner, and specific responses to the user queries can be provided in animated format based on how the construct is populated.

For example, text/a clause calling for shareholder approval of any updates to the enterprise financial model may be correlated to and classified as an impact upon a business function titled “Updates to Life Cycle Financial Model” and associated with the Treasury Department of a specified enterprise organization.

At step 303, all clauses in the unstructured legal data set bearing on the business function in question as identified at step 302 are identified and associated to the same correlation.

At step 304, each of the identified clauses are correlated to a specific legal authority type, such as contractual, regulatory, policy and the like. In the example cited at step 303, a shareholder approval requirement residing in a shareholders' agreement can be categorized as a contractual authority type.

Once all correlations of associated legal text have been identified, at step 305 all enterprise affiliate entities, together with any individual decision-makers or decision-making bodies within those entities, that possess any of the identified authorities are specified, along with correlations to the underlying source document and clause, as well as authority type.

At step 306, the actions individual decision-makers or decision-making bodies identified at step 305 are classified according to specified rules, such as endorsement, approval, consultation and the like.

At step 307, the data identified in steps 302, 303, 304, 305 and 306 are processed to identify the enterprise hierarchical philosophy, which generally provides insight on how most efficiently to sequence and process governance actions according to an overarching philosophy that is gleaned from the enterprise legal data, reviewed in its source, unstructured form.

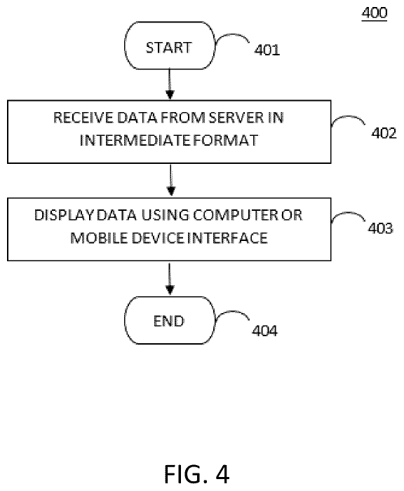

At step 308, the customization scripts 111 are applied to generate an array of binary data according to the sequencing and data values identified in steps 302, 303, 304, 305, 306 and 307, which are then encoded in the intermediate format as described in greater detail in FIG. 2 and FIG. 4 and the associated descriptions. After encoding to the intermediary format, the data are sent in the form of an array of binary format data from the server 102 to the native client 130 for rendering in accordance with the methodology described and depicted in FIG. 4 and associated descriptions. At this point, the method ends at step 309.

FIG. 4 is a flow diagram depicting a method 400 for accessing data rendered according to the construct 500 on a user computer or mobile device in accordance with embodiments of the present invention. The method begins at step 401.

At step 402, the native client 118 executing on the computer or mobile device 113 receives converted data (in the form of an array of binary format data structured according to the construct 500) from the server 101, where the data is encoded in an intermediate format such as JSON, XML, or the like.

At step 403, the native client 118 executes a series of rules to recognize certain data structures, objects, arrays and/or the like and render those constructs as animated displays on the device interface. The native client 118 uses the converted data to generate an interface for the customization script 111 that is representative of the structured data in the intermediate format ordered according to the construct.

In some embodiments, the native client 118 displays the animated outcomes from the converted data on the user computer or mobile device 113 by rendering each object using a native control. Instead of processing and displaying source data from the ERP or similar database service 104, the source unstructured legal data is converted according to the process depicted by FIG. 2 and FIG. 3 into an intermediate format that is recognizable to the native client 118 in order to display the animated renderings that address user queries 204 to the server 101. Accordingly, the native client 118 may utilize one or more native controls (i.e., applications) to render the converted data locally in order to display the objects in a suitable layout for both computers and mobile devices 113, with animations derived from a defined set of rules. The method then ends at step 404.

The foregoing description comprises a number of elements, devices, circuits and/or assemblies that perform various functions as described. These elements, devices, circuits, and/or assemblies are exemplary implementations of means for performing their respectively described functions. In some embodiments, the server application 107 represents a means for accessing voluminous, interconnected and unstructured legal data warehoused on an enterprise resource planning or other database system, and converting that data into a structured data set against which various algorithmic processes may be applied, thereby significantly reducing processing power requirements and reducing the volume of data trial needed for artificial intelligence algorithmic processes to produce reliable results when applied against the legal data. Collectively, the server application 107, the customization scripts 111 and/or the native client 118 may form a means for accessing, converting and applying such data.

While the foregoing is directed to some embodiments, other and further embodiments may be devised without departing from the basic scope thereof, and the scope thereof is determined by the claims that follow.

### Additional Aspects

Some additional aspects of the inventive embodiments described herein are explained below.

The description discusses an interface between the application server and the ERP or database server. However, this could also be accomplished in an environment where underlying source data is hosted on the application server.

Explained further here are the concepts of governance trees and enterprise hierarchical philosophy. Enterprise organizations consist of multiple affiliated enterprise entities, each of which are governed by their own internal organizational documents and legal requirements. Holistically, however, the affiliated group of companies operates in an environment of interconnections that derive from (1) their parent-child-sibling structure; (2) commonalities and reporting lines among individual leaders and governing bodies across the enterprise; (3) written policy documents; (4) contracts and (5) their regulatory environment and regulatory documents. How those five elements interrelate put the enterprise as a whole somewhere along a spectrum of enterprise hierarchical philosophies—namely, the overarching philosophical approach to how the interconnected companies behave together in relation to matters of governance. The spectrum of philosophies can be bounded on each end by two philosophical approaches. The first is “Checks & Balances”, which is an enterprise hierarchical philosophy that, in general, prioritizes the independence of decision-making bodies across the enterprise, values arm's-length dealings in all matters across the enterprise, and typically endeavors to ensure that decisions of each enterprise affiliate are made independently by the senior officers, boards of directors, and other governing bodies of such enterprise affiliate, with a progressive flow of information based on the outcomes of those decisions up the enterprise structure where structurally higher levels of authority (such as parent companies) can act or intervene (where the parent company is required to act at all) once subsidiary decisions have been independently considered and taken.

The second is “Enterprise-Wide Perspective”, which is an enterprise hierarchical philosophy that, in general, embraces an enterprise-wide perspective of risk and decision-making, and follows top-down control where the views of parent company(ies) are prioritized over any divergent views that emerge from the subsidiary enterprise entities, subject to the fiduciary duties of senior officers and board members and other legal requirements of independence and autonomy within subsidiary enterprise entities. In general, an enterprise that embraces the Enterprise-Wide Perspective philosophy will wish to ensure that, save where authorities have been specifically delegated and subject appropriate information sharing between business and legal leaders (including senior officers) and governing bodies (including boards of directors), all relevant information for a decision that impacts the enterprise is presented to the relevant parent company, and the views of the highest appropriate governing body or decision maker (including senior officers and boards of directors) of that parent company flow down through the enterprise and are expected to be given due consideration as the business and legal leaders and governing bodies of subsidiary enterprise entities consider the same or similar issues. Enterprise groups that fall closer to Checks & Balances will favor a bottom-up approach to governance, and those that fall closer to Enterprise-Wide Perspective will favor a top-down approach.

In addition, from the construct of binary data, once populated and once stakeholder mapping is complete, users are able to see common themes of interrelated governance approvals, which are driven based on the enterprise affiliate that is most directly impacted by a governance matter. Consider, for example, two affiliated companies owned by the same “TopCo”. One of them, “SPV”, is the owner of a major revenue-producing asset for the enterprise. Another, “O&MCo”, operates and maintains this asset (and likely others) across the enterprise. SPV and O&MCo are sibling companies, but each have different business models and overall corporate objectives and key performance indicators. SPV may be trying to minimize operating cost and maximize asset-level revenue, whereas O&MCo may be trying to maximize operating and maintenance charges to SPV (and others) and achieve the highest levels of operational and maintenance work. A decision related to the operation and maintenance plan of SPV's assets will require consideration by both SPV and O&MCo. If these companies were fully at arm's length, then we would consider SPV to be the customer and O&MCo to be the services provider, and the agreement between the two could be conceived as something of a “delegation of authority” in the sense that SPV will appoint O&MCo to operate and maintain the asset according to principles and standards of performance set out in the contract, and we may further imagine that on matters of critical importance (such as all things impacting budget(s) or costs that SPV must incur), O&MCo may be contractually required to secure SPV's approval.

If something arises that is fully delegated to O&MCo in the sense that no approval of SPV is contractually required, then the matter must be considered by O&MCo according to O&MCo's internal corporate governance requirements. If those requirements dictate that parent company consent is needed, then O&MCo will seek TopCo approval. If not, then O&MCo will proceed based on internal approvals alone. In this sense, considering the hierarchical approval flows on the O&MCo side, the O&MCo “governance tree” or chain of approvals would include O&MCo owned by TopCo, and cither O&MCo can decide on its own or must also secure TopCo approval. If the same approval flow on the SPV side is considered, the SPV “governance tree” or chain of approvals would include SPV, owned by TopCo, but with a portion of relevant governance matters delegated to O&MCo (shown in a subsidiary position to SPV by virtue of contractual delegation, even though the two companies are siblings). In this example, O&MCo would be the highest authority level in the SPV “governance tree” by virtue of the fact that SPV has delegated decision-making contractually to O&MCo.

On the other hand, if something arises that involves a contractual requirement to seck customer approval, then O&MCo will still proceed with its own internal approvals, but must also solicit SPV's views. Consider then the SPV “governance tree”, in contrast to the example described in the paragraph above; SPV's approval will be needed, and depending on SPV's internal governance requirements, the approval of TopCo may also be required. The O&MCo “governance trec” will be precisely as in the case in the paragraph above.

The way, then, in which these “governance trees” interact, together with the enterprise hierarchical philosophy, determines the sequencing of approvals according to the construct.

A definition can simply refer to a narrative text description in sufficient detail to be ascertainable by reference to the source legal documents. In the use case of financial model updates shown herein, for instance, a definition for the business function “Update Project Life-Cycle Financial Model” might be “the project life cycle financial model (as updated and amended from time to time) which SPV shall be responsible for developing and maintaining”.

In this way, the construct itself, once populated, contains all the “vectors” of information necessary to generate the answers to user queries, and also will have data capture to associate the source clauses with the construct mapping (not shown in the Governance Array diagram, but (for example) the correlations described above of the source text to the “1”s and “0”s will be stored, and this is part of the manner in which the neural network is trained (aided by manual input). Therefore, the construct itself and the data capture elements of source text mapping to the construct population can be separately stored and useful for machine learning and/or predictive capabilities.

### Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification, unless clearly indicated to the contrary, should be understood to mean “at least one.”

The phrase “and/or,” as used herein in the specification, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either”, “one of”, “only one of”, or “exactly one of.” “Consisting essentially of” shall have its ordinary meaning as used in the field of patent law.

As used herein in the specification, the phrase “at least one,” in reference to a list of one or more elements, should be understood to mean at least one element selected from any one or more of the elements in the list of elements, but not necessarily including at least one of each and every clement specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the specification above, all transitional phrases such as “comprising”, “including”, “carrying”, “having”, “containing”, “involving”, “holding”, “composed of”, and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A server for data processing of unstructured data for presentation on a user device, the server communicably coupled to a database server for storing the unstructured data, the server further communicably coupled to the user device for consuming the unstructured data, the server comprising at least one processor configured to:
receive the unstructured data from the database server, the unstructured data associated with an organization;
receive a specification of a construct including an organization structure associated with the organization for a function of the organization, the organization structure including a set of elements, the set of elements including one or more of:
a set of departments of the organization;
a set of affiliates of the organization; or
a set of authority entities of the organization,
the construct further including a set of fields associated with two elements of the set of elements, each field indicative of a mapping between its two elements;
populate the set of fields of the construct by mapping at least a first portion of the unstructured data based on the organization structure of the construct to generate an updated construct including a set of field entries;
convert the updated construct into a data interchange format file;
receive, from the user device, a query for a second portion of the unstructured data that is subsumed by the first portion of the unstructured data;
convert, based on the query, a portion of the data interchange format file corresponding to the second portion of the unstructured data into response data, the response data including a specification of a visual display of the response data; and
transmit, to the user device and responsive to the query, the response data, such that the user device renders the response data on a display of the user device based on the specification of the visual display.

2. The server of claim 1, wherein each field entry of the set of field entries is a binary number.

3. The server of claim 1, wherein the data interchange format file includes a serialized representation of the updated construct.

4. The server of claim 1, wherein the mapping includes applying a trained neural network to at least part of the first portion of the unstructured data.

5. The server of claim 1, wherein the function is a first function, the specification of a construct including the organization structure being associated with the organization for a set of functions of the organization including the first function.

6. The server of claim 1, wherein the unstructured data includes text.

7. The server of claim 6, wherein the unstructured data includes a set of text documents.

8. The server of claim 7, wherein the first portion of the unstructured data includes a set of clauses within the set of text documents.

9. A method for data processing of unstructured data for presentation on a user device, the method comprising:
receiving the unstructured data from a database server, the unstructured data associated with an organization;
receiving a specification of a construct including an organization structure associated with the organization for a function of the organization, the organization structure including a set of elements, the set of elements including one or more of:
a set of departments of the organization;
a set of affiliates of the organization; or
a set of authority entities of the organization,
the construct further including a set of fields associated with two elements of the set of elements, each field indicative of a mapping between its two elements;
populating the set of fields of the construct by mapping at least a first portion of the unstructured data based on the organization structure of the construct to generate an updated construct including a set of field entries;
converting the updated construct into a data interchange format file;
receiving, from the user device, a query for a second portion of the unstructured data that is subsumed by the first portion of the unstructured data;
converting, based on the query, a portion of the data interchange format file corresponding to the second portion of the unstructured data into response data, the response data including a specification of a visual display of the response data; and
transmitting, to the user device and responsive to the query, the response data, such that the user device renders the response data on a display of the user device based on the specification of the visual display.

10. The method of claim 9, wherein each field entry of the set of field entries is a binary number.

11. The method of claim 9, wherein the data interchange format file includes a serialized representation of the updated construct.

12. The method of claim 9, wherein the mapping includes applying a trained neural network to at least part of the first portion of the unstructured data.

13. The method of claim 9, wherein the function is a first function, the specification of a construct including the organization structure being associated with the organization for a set of functions of the organization including the first function.

14. The method of claim 9, wherein the unstructured data includes text.

15. The method of claim 14, wherein the unstructured data includes a set of text documents.

16. The method of claim 15, wherein the first portion of the unstructured data includes a set of clauses within the set of text documents.

17. (canceled)

18. (canceled)

19. (canceled)

20. (canceled)

21. (canceled)

22. (canceled)

23. (canceled)

24. (canceled)

25. A method for converting unstructured data into a structured data set, the method comprising:
parsing the unstructured data, the unstructured data being in one or more document formats;
ordering the parsed data into a construct to generate an updated construct, the construct representing a structured array of an organization structure and including a set of elements, the set of elements including one or more of:
a set of departments of the organization;
a set of affiliates of the organization; or
a set of authority entities of the organization;
converting the updated construct into a data interchange format file, the data interchange format file including a serialized representation of the updated construct; and
communicating the data interchange format file to a user device to facilitate display of the parsed data as animations on the user device.

26. The method of claim 25, wherein the data interchange format file is compatible with a native client executing on the user device and configured to display the animations on the user device.

27. The method of claim 25, wherein communicating the data interchange format file to the user device further comprises communicating the data interchange format file using at least one a hyper-text transfer protocol, telnet, secure socket layer or rlogin.
